(19) United States
(12) Patent Application Publication
(10) Pub. No.: US 2024/0041040 A1
(43) Pub. Date: Feb. 8, 2024

(54) RODENT REPELLENT COMPOSITIONS

(71) Applicants: The United States of America, as Represented by the Secretary of Agriculture, Washington, DC (US); Arkion Life Sciences, LLC, New Castle, DE (US)

(72) Inventors: Scott J. Werner, Wellington, CO (US); Kenneth E Ballinger, JR., East Wakefield, NH (US)

(73) Assignees: The United States of America, as Represented by the Secretary of Agriculture, Washington, DC (US); Arkion Life Sciences, LLC, New Castle, DE (US)

(21) Appl. No.: 18/223,659

(22) Filed: Jul. 19, 2023

Related U.S. Application Data
(60) Provisional application No. 63/390,672, filed on Jul. 20, 2022.

(51) Int. Cl. A01N 43/40; A01N 25/04; A01P 17/00

(52) U.S. Cl. CPC A01N 43/40; A01N 25/04; A01P 17/00

(57) ABSTRACT

In certain aspects, the present disclosure relates to a composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water. The disclosure also relates to methods of repelling a rodent from a substrate comprising applying to a substrate the compositions described herein.

### RELATED APPLICATIONS

This application claims priority to U.S. Provisional Patent Application No. 63/390,672 filed on Jul. 20, 2022, the contents of which are incorporated herein in their entirety.

### BACKGROUND

Rodents contaminate food and frequented areas with feces, urine, and hair. They carry diseases, such as spirochetal jaundice and murine typhus. According to the Centers for Disease Control and Prevention: Worldwide, rats and mice spread over 35 diseases. These diseases can be spread to humans directly, through handling of rodents, through contact with rodent feces, urine, or saliva, or through rodent bites. Diseases carried by rodents can also be spread to humans indirectly through ticks, mites or fleas that have fed on an infected rodent. Accordingly, a need exists for safe, effective and affordable compositions and methods for repelling rodents.

### SUMMARY OF THE INVENTION

In certain aspects, the disclosure relates to a composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water. In some embodiments, the composition comprises 35% vol/vol castor oil, 30% vol/vol propylene glycol, 10% vol/vol oleic acid, 20% wt/vol rodent repellent, and 5% vol/vol water. In some embodiments, the composition comprises 40% vol/vol castor oil, 30% vol/vol propylene glycol, 10% vol/vol oleic acid, and 20% wt/vol rodent repellent. In some embodiments, the rodent repellent is selected from the group consisting of capsaicin, cinnamaldehyde, methylnonalketone (MNK), linalool, and piperine. In some embodiments, the rodent repellent is piperine.

In certain aspects, the disclosure relates to a method of repelling a rodent from a substrate comprising applying to a substrate a composition as described herein, thereby repelling the rodent from the substrate.

In certain aspects, the disclosure relates to a method of enhancing rodent repellency from a substrate comprising applying to a substrate a composition as described herein, thereby enhancing rodent repellency from the substrate.

In some embodiments, the rodent is a mouse. In some embodiments, the composition increases rodent repellency relative to a composition that comprises the rodent repellent but does not comprise castor oil, propylene glycol, and oleic acid. In some embodiments, the castor oil, propylene glycol and oleic acid have a synergistic effect with the rodent repellent in enhancing rodent repellency.

### BRIEF DESCRIPTION OF THE FIGURES

FIGS. 1A-1F show the frequency of mouse traverse through repellent-treated sides of an experimental T-maze. The formulation in FIG. 1A is 0.75 g capsaicin suspended in 15 mL ethanol. The formulation in FIG. 1B is 20 g cinnamaldehyde, 35 mL castor oil, 5 mL water, 30 mL propylene glycol, and 10 mL oleic acid. The formulation in FIG. 1C is 20 g methyl nonyl ketone (MNK), 40 mL castor oil, 30 mL propylene glycol, and 10 mL oleic acid. The formulation in FIG. 1D is 20 g linalool, 35 mL castor oil, 5 mL water, 30 mL propylene glycol, and 10 mL oleic acid. The formulation in FIG. 1E is 0.75 g piperine suspended in 15 mL ethanol. The formulation in FIG. 1F is 20 g piperine, 40 mL castor oil, 30 mL propylene glycol, and 10 mL oleic acid.

FIG. 2 shows the frequency of mouse traverse through piperine-treated and control sides of an experimental T-maze. The piperine-treated side of the T-maze (PIP Full Traverse; 2022) was treated with 20 g piperine, 40 mL castor oil, 30 mL propylene glycol, and 10 mL oleic acid. The control side of the T-maze (Control Full Traverse) was treated with 40 mL castor oil, 30 mL propylene glycol, and 10 mL oleic acid.

### DETAILED DESCRIPTION OF THE INVENTION

### I. Definitions

As used herein, the term “repellency” means the percent decrease in consumption (or occupancy) of a treated substrate relative to an untreated substrate. The term “effective repellency” means at least a 5% decrease in consumption (or occupancy) of a treated substrate relative to an untreated substrate. The effective repellency can be a 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% decrease in consumption (or occupancy) of a treated substrate relative to an untreated substrate. These values can be used to define a range, such as 50% to 75%, or 75% to 85%, or 25% to 50% decrease in consumption (or occupancy) of a treated substrate relative to an untreated substrate.

As used herein, the term “attraction” means the percent increase in consumption (or occupancy) of a treated substrate relative to an untreated substrate. The term “effective attraction” means at least a 5% increase in consumption (or occupancy) of a treated substrate relative to an untreated substrate. The effective attraction can be a 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% increase in consumption (or occupancy) of a treated substrate relative to an untreated substrate. These values can be used to define a range, such as 50% to 75%, or 75% to 85%, or 25% to 50% increase in consumption (or occupancy) of a treated substrate relative to an untreated substrate.

The term “relevant behavioral response” as used herein refers to the animal's reaction to either effective repellency or effective attraction. For example, when an animal exhibits a relevant behavioral response of decreased consumption (or occupancy) of a treated substrate relative to an untreated substrate, that response is the result of effective repellency. Alternatively, when an animal exhibits a relevant behavioral response of increased consumption (or occupancy) of a treated substrate relative to an untreated substrate, that response is the result of effective attraction. In addition, the percentage values provided in the two paragraphs preceding this one can be used with the term “relevant behavioral response.” For example, 50% repellency is equivalent to a behavioral response at a level of 50% decreased consumption (or occupancy) of a treated substrate relative to an untreated substrate.

### II. Compositions

In certain aspects, the disclosure relates to a composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water.

Rodent repellents suitable for use in the present disclosure include but are not limited to: capsaicin, cinnamaldehyde, MNK (methylnonalketone), linalool, piperine, flutolanil, anthranilates, methiocarb, caffeine, chlorpyrifos, cyhalothrin, methyl phenyl acetate, ethyl phenyl acetate, o-amino acerophenone, 2-amino-4,5-dimethyl ecetophenone, veratroyl amine, cinnamic aldehyde, cinnamic acid, cinnamide, allyl isothiocyanate, TRPV1, denatonium benzoate, quebracho, sucrose octaacetate, quinine, quinine hydrochloride, magnesium sulfate, o-aminoacetophenone, emetine dihydrochloride, aluminum ammonium sulphate, putrescent and volatile animal products (e.g. eggs, urine, blood meal, castor oil), putrescent and volatile plant products (e.g. pine needle oil, garlic oil, sinigrin), d-pulegone, thiram, glucosinolate, polygodial, and combinations thereof.

In some embodiments, the rodent repellent is selected from the group consisting of capsaicin, cinnamaldehyde, MNK (methylnonalketone), linalool and piperine. In a particular embodiment, the rodent repellent is piperine.

In some embodiments, the rodent repellent repels animals on its own, i.e., the animal repellent does not require combination with another compound (e.g., a visual cue) to repel animals (e.g., rodents). In some embodiments, the compositions described herein do not comprises a visual cue. In some embodiments, the compositions described herein do not comprise an anthraquinone compound (e.g., 9,10-anthraquinone).

Attractant agents suitable for use in the present disclosure include but are not limited to food-based agents (e.g., grains and grain products, seeds and seed products, nuts and nut products, nut butter, fruit and fruit products, dairy products, confectionery ingredients), fats (e.g., plant fats, animal fats), protein, and combinations thereof.

In some embodiments, the attractant agent is a terpene, e.g., a terpene separated from its natural oil. Suitable terpenes include, but are not limited to α-pinene (pines), linalool (mints, lavender), myrcene (myrtles, cannabis), β-caryophyllene (peppercorn, cannabis, rosemary, hops), caryophyllene oxide (cannabis), α-humulene (hops), limonene (citrus), terpinolene, carene (cedar, rosemary), terpineols (cardamom, cajuput, pine, petitgrain, junipers, orange peel), nerol (lemon grass), menthol (mints), camphor (camphor trees), β-selinene (celery), citral (lemon myrtle, lemongrass, lemon, lime, orange), retinol (vitamin A; cod liver oil, liver, eggs, cheese, milk), β-carotene (carrots), P-cymene (cumin, thyme), terpinenes (cardamom, marjoram), citronellal (lemon), thymol (thyme), carvacrol (oregano), carvone (caraway, spearmint, dill), borneol (valerian, camphor, sambong), cinnamaldehyde (cinnamon), eugenol (clove, nutmeg, cinnamon, basil, bay leaf), vanillin (vanilla bean), safrole (sassafras), allyl-isothiocyanate (mustard, radish, horseradish, wasabi), allicin (garlic), eucalyptol (eucalyptus), farnesenes (apples), zingiberene (ginger), parthenolide (feverfew), artemisinin (sweet wormwood), taxol (Pacific yew), cholesterol (animal cells), hopane (dammar resin), geraniol (rose, wine grape), and zeaxanthin (paprika, corn, saffron, wolfberries).

In some embodiments, the attractant agent is one of the compounds provided below.

A Receptor Antagonists

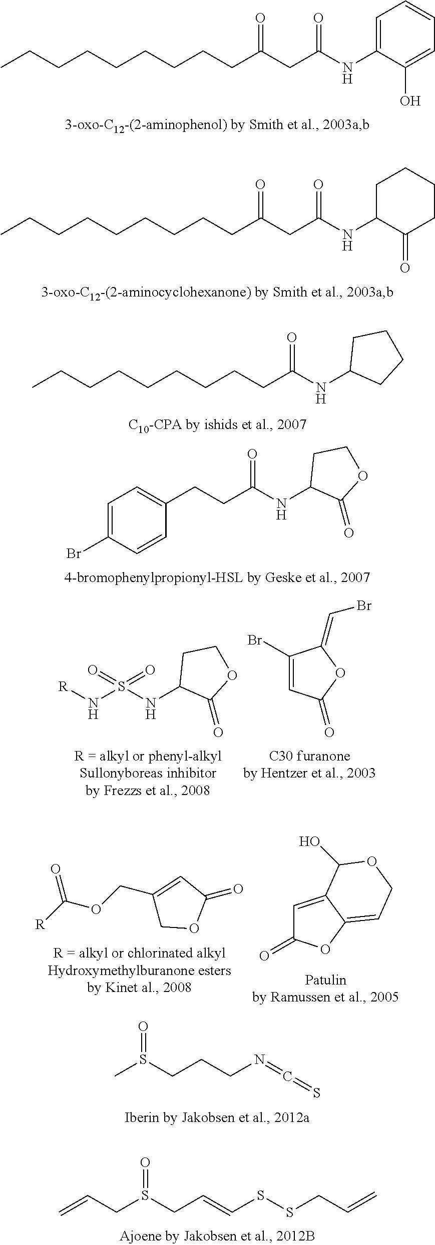

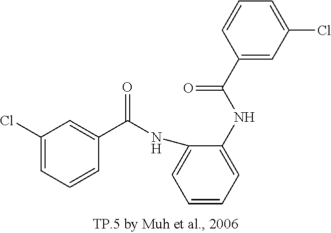 [SMILES: O=C(Nc1ccccc1NC(=O)c1cccc(Cl)c1)c1cccc(Cl)c1]

B Signal Synthesis Inhibitors

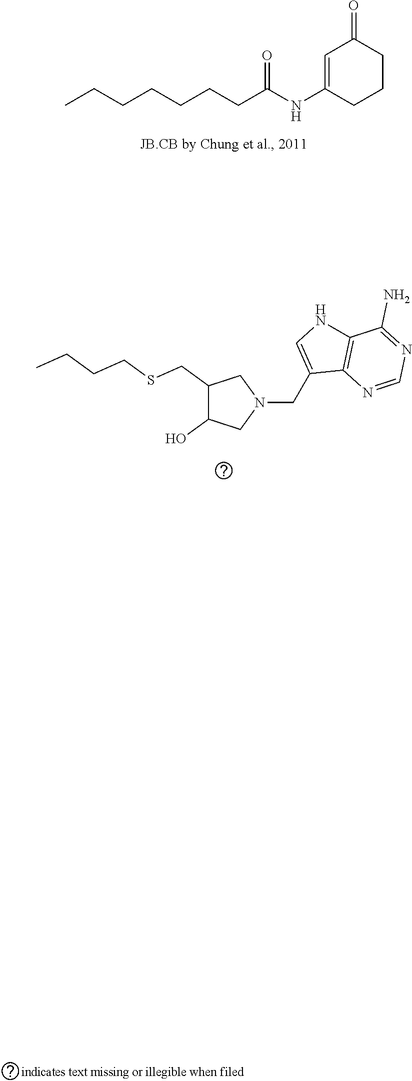 [SMILES: CCCCCCCC(=O)NC1=CC(=O)CCC1 ; CCCCSCC1CN(Cc2c[nH]c3c(N)ncnc23)CC1O]

Terpenes

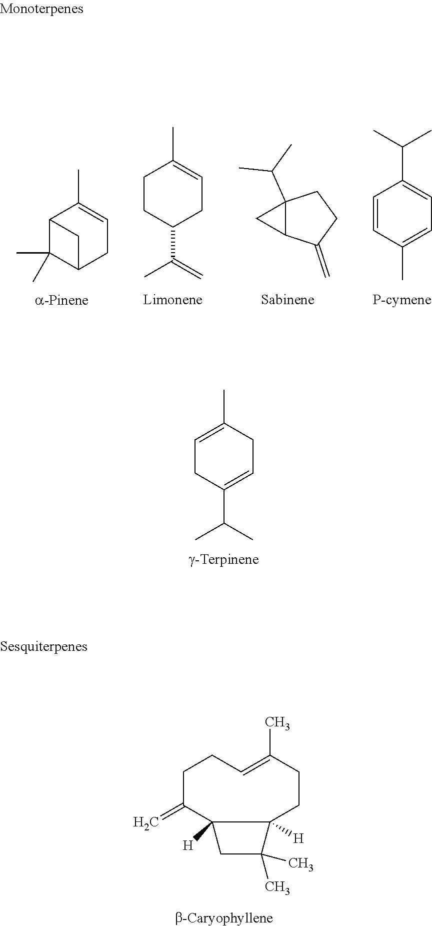

Terpenoids

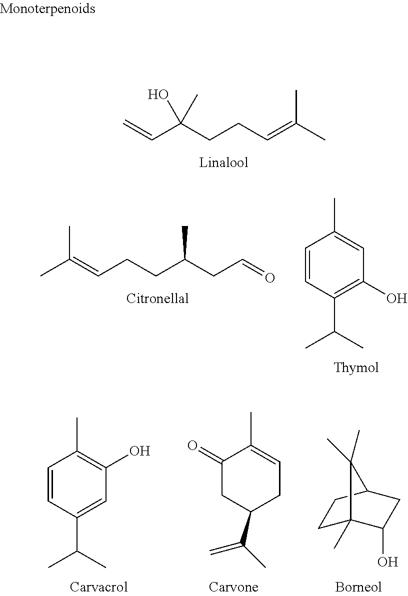

Phenylpropanoids

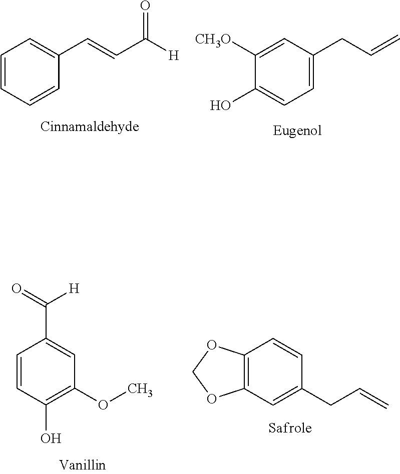

Others

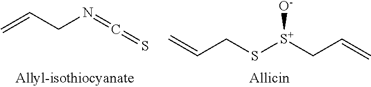

Hemiterpenoids

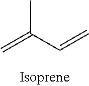

Monoterpenoids

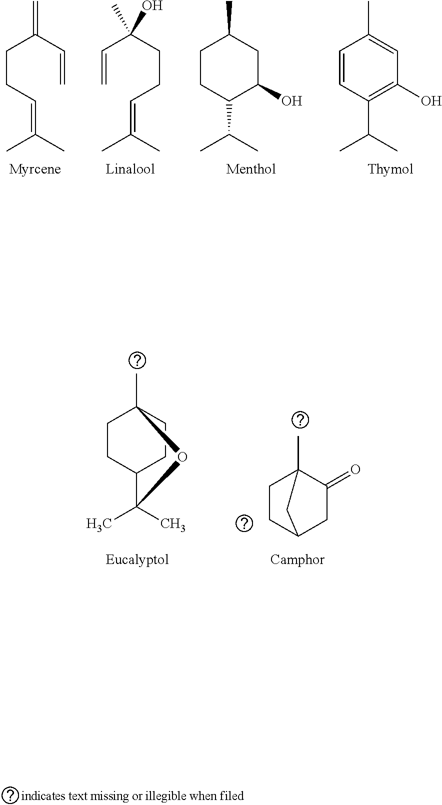

Sesquiterpenoids

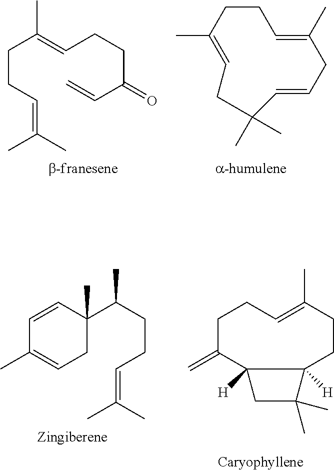

Sesquiterpenoid lactones

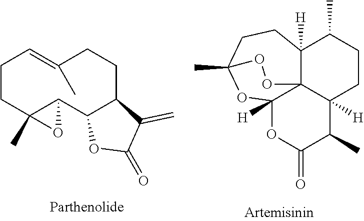 [SMILES: C=C1C(=O)O[C@@H]2[C@H]3O[C@]3(C)CC/C=C(\C)CC[C@@H]12 ; C[C@@H]1CC[C@H]2[C@@H](C)C(=O)O[C@@H]3O[C@]4(C)CC[C@@H]1C32OO4]

Diterpenoids

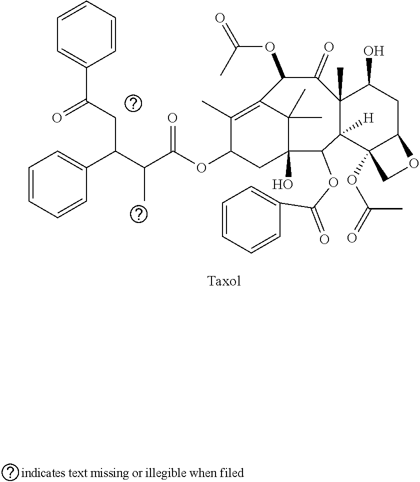

Triterpenoids

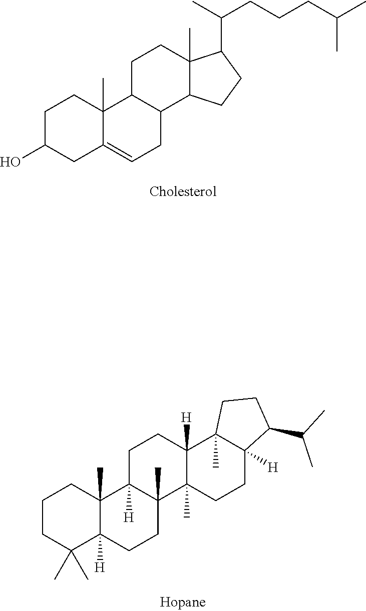

Tetraternenoids

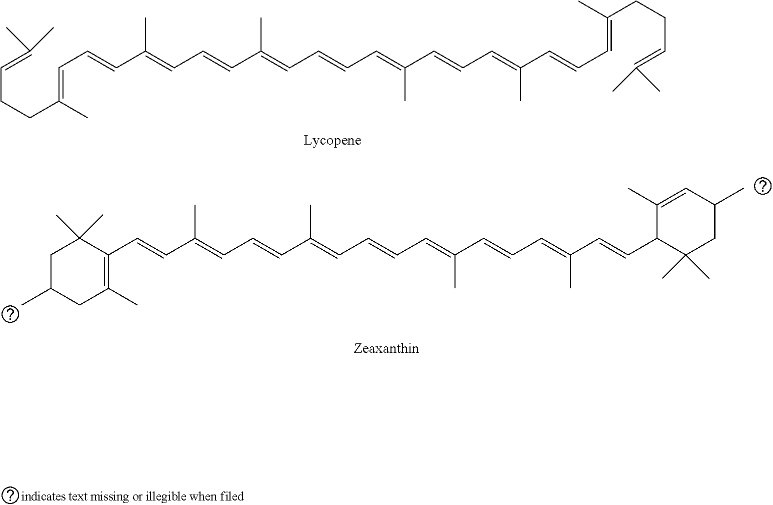

In some embodiments, the composition comprises an effective amount of the rodent repellent or attractant. As used herein, an “effective amount” is defined as that amount which results in a significant repellence or attraction of the rodents from a treated target or substrate in comparison to an untreated control target or substrate. The actual effective amount will vary with the particular repellent or attractant selected, its formulation, the animal, the target or substrate, and environmental factors, and may be readily determined by routine controlled experimentation. Suitable amounts and formulations are described in the prior art as noted hereinabove, and are also provided by the repellent and attractant manufacturers and suppliers. By way of example and without being limited thereto, an effective amount of the rodent repellent in the composition can be about, or less than about, 15%, 16%, 17%, 18%, 19%, 20%, 21%, 22%, 23%, 24% or 25% weight/volume (wt/vol) of the rodent repellent. In some embodiments, the composition comprises at least about 15%, 16%, 17%, 18%, 19%, 20%, 21%, 22%, 23%, 24% or 25% wt/vol of the rodent repellent. Any of these amounts can also be used to define a range for the amount of rodent repellent in the composition, such as between about 15% to about 25% wt/vol. In a particular embodiment, the composition comprises 20% wt/vol of the animal repellent.

In some embodiments, the composition comprises about or at least about 30%, 31%, 32%, 33%, 34%, 35%, 36%, 37%, 38%, 39%, 40%, 41%, 42%, 43%, 44% or 45% vol/vol castor oil. In some embodiments, the composition comprises less than about 30%, 31%, 32%, 33%, 34%, 35%, 36%, 37%, 38%, 39%, 40%, 41%, 42%, 43%, 44% or 45% vol/vol castor oil. Any of these values may be used to define a range for the concentration of castor oil in the composition. For example, in some embodiments, the composition comprises about 30% to about 40% vol/vol castor oil. In some embodiments, the composition comprises 40% vol/vol castor oil. In some embodiments, the composition comprises 35% vol/vol castor oil.

In some embodiments, the composition comprises about or at least about 25%, 26%, 27%, 28%, 29% 30%, 31%, 32%, 33%, 34% or 35% vol/vol propylene glycol. In some embodiments, the composition comprises less than about 25%, 26%, 27%, 28%, 29% 30%, 31%, 32%, 33%, 34% or 35% vol/vol propylene glycol. Any of these values may be used to define a range for the concentration of propylene glycol in the composition. For example, in some embodiments, the composition comprises about 25% to about 35% vol/vol propylene glycol. In some embodiments, the composition comprises 30% vol/vol propylene glycol.

In some embodiments, the composition comprises about or at least about 5%, 6%, 7%, 8%, 9%, 10%, 11%, 12%, 13%, 14% or 15% vol/vol oleic acid. In some embodiments, the composition comprises less than about 5%, 6%, 7%, 8%, 9%, 10%, 11%, 12%, 13%, 14% or 15% vol/vol oleic acid. Any of these values may be used to define a range for the concentration of oleic acid in the composition. For example, in some embodiments, the concentration of oleic acid in the composition is about 5% to about 15% vol/vol. In some embodiments, the composition comprises 10% vol/vol oleic acid.

In some embodiments, the composition comprises about 0%, 1%, 2%, 3%, 4%, 5%, 6%, 7%, 8%, 9% or 10% volume/volume (vol/vol) water. In some embodiments, the composition comprises at least about 1%, 2%, 3%, 4%, 5%, 6%, 7%, 8%, 9% or 10% vol/vol water. In some embodiments, the composition comprises less than about 1%, 2%, 3%, 4%, 5%, 6%, 7%, 8%, 9% or 10% vol/vol water. Any of these values may be used to define a range for the concentration of water in the composition. For example, in some embodiments, the concentration of water in the composition is about 1% to 5% vol/vol, or about 0% to 10% vol/vol. In some embodiments, the composition comprises 5% vol/vol water. In some embodiments, the composition does not contain water.

In some embodiments, the composition comprises 35% vol/vol castor oil, 30% vol/vol propylene glycol, 10% vol/vol oleic acid, 20% wt/vol rodent repellent, and 5% vol/vol water. In some embodiments, the composition comprises 40% vol/vol castor oil, 30% vol/vol propylene glycol, 10% vol/vol oleic acid, and 20% wt/vol rodent repellent.

The compositions described herein may further comprise an acceptable carrier as is known in the art. Formulations of the compositions can vary with the particular target or substrate and method of application. The compositions may, for example, be formulated as solutions, emulsions, emulsifiable concentrates, suspension concentrates, wettable powders, dusts, granules, adherent dusts or granules, and aerosols. In particular, the carrier can be agronomically acceptable and suitable for application onto structures, agricultural fields or crops, seeds, seedlings, orchards, vineyards, livestock feed, fertilizers, pesticides, animal or insect baits, and combinations thereof. The additional acceptable carrier can be a liquid or solid phase carrier, including but not limited to aqueous surfactant mixtures, alcohols, ethers, hydrocarbons, halogenated hydrocarbons, glycols, ketones, esters, oils (natural or synthetic), clays, kaolinite, silicas, cellulose, rubber, talc, vermiculate, and synthetic polymers. The compositions can also be formulated in admixture with other agriculturally beneficial agents, including but not limited to, ultraviolet stabilizers, antioxidants, baits, adjuvants, herbicidal agents, fertilizers, and pesticides including insecticides and fungicides. The compositions of the present disclosure can also contain one or more adjuvants, such as those routinely used in agriculture to adhere compounds to the surface of plant material.

In some embodiments, the animal to be repelled or attracted is a mammal. In some embodiments, the animal to be repelled or attracted is a dichromatic animal. Dichromatic animals are those animals that use only two distinct types of photoreceptors for color vision, generally including placental mammals and excluding sea mammals (pinnipeds and cetaceans; monochromats), primates closely related to humans (i.e. trichromats) and most birds (tetrachromats). In some embodiments, the animal to be repelled or attracted is selected from the group consisting of mice, rats, rabbits, squirrels, chipmunks raccoons, dogs, cats, groundhogs, skunks, deer, wolves, coyotes, boars, bears and moose.

In certain aspects, the disclosure relates to a composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water.

In some embodiments, the animal to be repelled or attracted is a mammal. In some embodiments, the animal to be repelled or attracted is not a bird. In some embodiment, the animal to be repelled or attracted is a rodent. Suitable rodents include, but are not limited to, mice and voles, field mice and meadow mice (Cricetidae); house mice, wood mice, black rats and brown rats (Muridae); ground squirrels, tree squirrels, flying squirrels, marmots and prairie dogs (Sciuridae)); pocket gophers (Geomyidae); mountain beaver (Aplodontidae); kangaroo rats, kangaroo mice and pocket mice (Heteromyidae); beavers (Castoridae); scaly-tailed squirrels (Anomaluridae); springhaas (Pedetidae); mole rats (Spalacidae and Bathyergidae); bamboo rats (Rhizomyidae); dormice (Gliridae, Platacanthomyidae and Seleviniidae); jumping mice (Zapodidae); jerboas (Dipodidae); porcupines (Hystricidae and Erethizontidae); cavies (Caviidae); capybara (Hydrochoeridae); pacaranas (Dinomyidae); agoutis and pacas (Dasyproctidae and Agoutidae); chinchillas and vizcachas (Chinchillidae); hutias (Capromyidae); nutria (Myocastoridae); hedge rats and octodonts (Octodontidae); tuco-tucos (Ctenomyidae); chinchilla rats (Abrocomidae); spiny rats (Echimyidae); cane rats (Thryonomyidae); dassie rats (Petromuridae); spring hare (Pedetidae) and gundis (Ctenodactylidae). In a particular embodiment, the animal to be repelled or attracted is a mouse.

### III. Methods

In certain aspects, the disclosure relates to a method of repelling an animal from a substrate comprising applying to a substrate a composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water, thereby repelling the animal from the substrate.

In certain aspects, the disclosure relates to a method of repelling a rodent from a substrate comprising applying to a substrate a composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water, thereby repelling the rodent from the substrate.

The compositions described herein can be used to repel animals anywhere they pose a nuisance or, more importantly, to prevent or minimize economic damage, particularly to agricultural products. The compositions can be applied on any substrate or spatial location of concern from which animals are to be repelled. Particular substrates include, but are not limited to, one or more of physical structures (e.g., walls, fences or buildings), agricultural fields or crops, seeds, seedlings, orchards, vineyards, livestock feed, fertilizers, pesticides, animal or insect baits, and combinations thereof. Crops include, but are not limited to, one or more of corn, fruit, grains, grasses, legumes, lettuce, millet, oats, rice, row crops, sorghum, sunflower, tree nuts, turf, vegetables, and wheat.

In some embodiments, applying the composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water increases rodent repellency relative to the same amount of the rodent repellent applied alone. In some embodiments, applying the composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water increases rodent repellency relative to a composition comprising the same amount of the rodent repellent but not comprising castor oil, propylene glycol and oleic acid. In some embodiments, the castor oil, propylene glycol and oleic acid have a synergistic effect with the rodent repellent in enhancing rodent repellency. In some embodiments, applying the compositions described herein to the substrate enhances rodent repellency by at least 1%, 2%, 3%, 4%, 5%, 6%, 7%, 8%, 9%, 10%, 15%, 20%, 25%, 30%, 35%, 45%, 50%, 60%, 70%, 80%, 90% or 100% relative to applying the animal repellent alone. In some embodiments, applying the compositions described herein to the substrate enhances rodent repellency by at least 1%, 2%, 3%, 4%, 5%, 6%, 7%, 8%, 9%, 10%, 15%, 20%, 25%, 30%, 35%, 45%, 50%, 60%, 70%, 80%, 90% or 100% relative to a composition comprising the same amount of the rodent repellent but not comprising castor oil, propylene glycol and oleic acid.

### EXAMPLES

### Example 1. Frequency of Mouse Traverse and Mouse Occupancy in Repellent-Treated Sides of an Experimental T-Maze

### Experimental Methods

For the purpose of comparatively evaluating the repellency of plant secondary compounds on rodent spatial and feeding behavior, this study involved behavioral assays within experimental T-mazes. The candidate plant secondary compounds tested in this study are capsaicin, cinnamaldehyde, methyl nonyl ketone (MNK), linalool, and piperine. We conducted behavioral assays within experimental T-mazes. For each T-maze experiment (one treatment per experiment), we used eight to ten (n=8-10 mice per treatment; dependent upon live capture success) experimentally-naïve house mice (Mus musculus). Mice (either sex) were opportunistically assigned to test replicates based upon their availability and condition. Subsequent to the successful live-capture of house mice in northern Colorado, mice were quarantined for at least five days within individual-mouse shoe boxes. We used two (2) double-wide (6-7 m wide) or triple-wide (14 m wide) testing rooms to conduct these T-maze experiments (i.e., two T-maze experiments were conducted concurrently, with 8-10 mazes in each of two testing rooms).

The treatment groups are shown in Table 1 below.

TABLE 1
Treatment groups for T-maze experiments

| | Plant | |
|---|---|---|
| | secondary | |
| Group | compound | Formulation |
| 1 | Capsaicin | 0.75 g capsaicin (5% wt/vol) in 15 mL ethanol |
| 2 | Cinnamalde- | 20 g cinnamaldehyde (20% wt/vol), 35 mL castor oil |
| | hyde | (35% vol/vol), 5 mL water (5% vol/vol), 30 mL |
| | | propylene glycol (30% vol/vol), and 10 mL oleic |
| | | acid (10% vol/vol) |
| 3 | Methyl | 20 g methyl nonyl ketone (MNK) (20% wt/vol), 40 |
| | nonyl ketone | mL castor oil (40% vol/vol), 30 mL propylene glycol |
| | (MNK) | (30% vol/vol), and 10 mL oleic acid (10% vol/vol) |
| 4 | Linalool | 20 g linalool (20% wt/vol), 35 mL castor oil (35% |
| | | vol/vol), 5 mL water (5% vol/vol), 30 mL propylene |
| | | glycol (30% vol/vol), and 10 mL oleic acid (10% |
| | | vol/vol) |
| 5 | Piperine | 0.75 g piperine (5% wt/vol) in 15 mL ethanol |
| 6 | Piperine | 20 g piperine (20% wt/vol), 40 mL castor oil (40% |
| | | vol/vol), 30 mL propylene glycol (30% vol/vol), and |
| | | 10 mL oleic acid (10% vol/vol) |
| 7 | Control | 40 mL castor oil, 30 mL propylene glycol, and 10 |
| | | mL oleic acid. |

For the purpose of comparatively evaluating the repellency of plant secondary compounds as structural barriers for rodents, this study involved behavioral assays within individual cages.

### T-maze Experiments

For each of 6-8 T-maze experiments, we individually introduced house mice within 8-10 experimental T-mazes to initiate each experiment. The maximum number of mice that were subjected to the maze at one time was one mouse per maze. The T-mazes were constructed of clear PVC pipe (5 cm dia.), PVC connectors (i.e. “T” couplers) and plastic nest boxes used in previous investigations of the spatial behavior of wild rodents in captivity. One PVC pipe (each 2.4 m long) extended in each of opposite directions (e.g. north, south) from the central “T” used to introduce a mouse within each experimental maze. An enclosed nest box (e.g. ≥25 cm long, ≥cm wide, ≥15 cm tall) was connected (securely, not air-tight) to each of the two terminating ends of each “T” maze. Daily maintenance of test subjects was provided thru each nest box, including water and bedding material (e.g. cotton balls, burlap swatches).

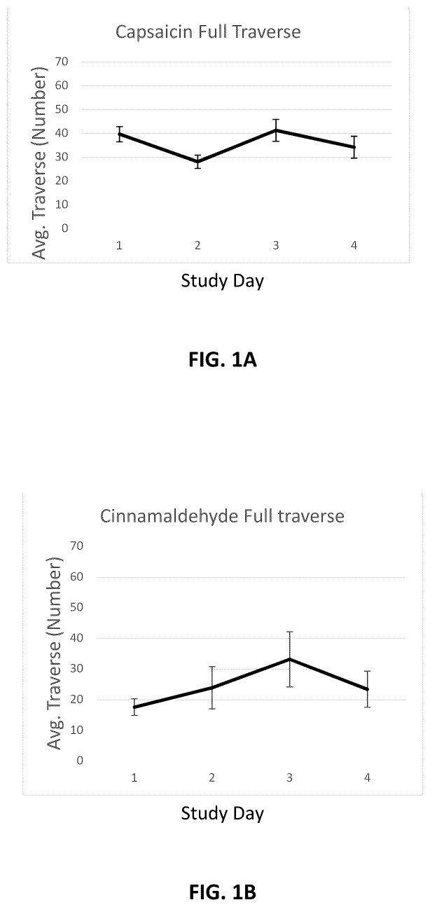

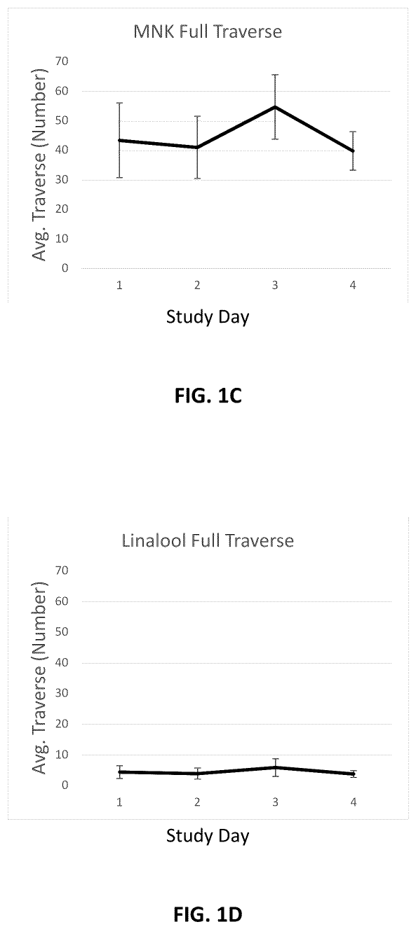

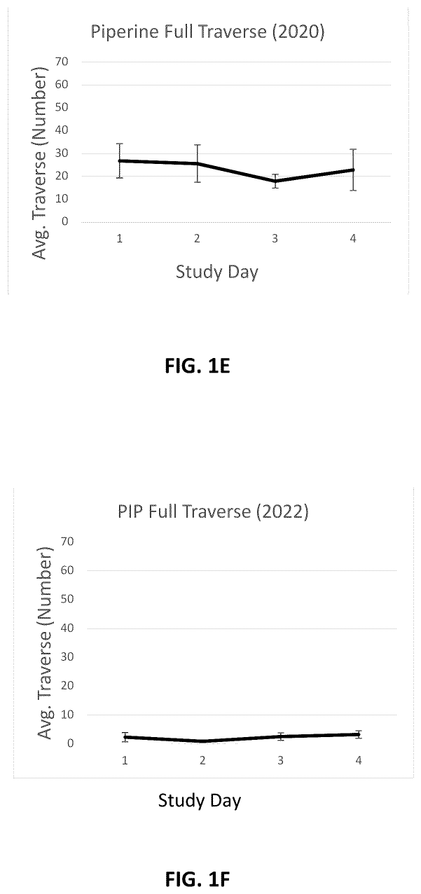

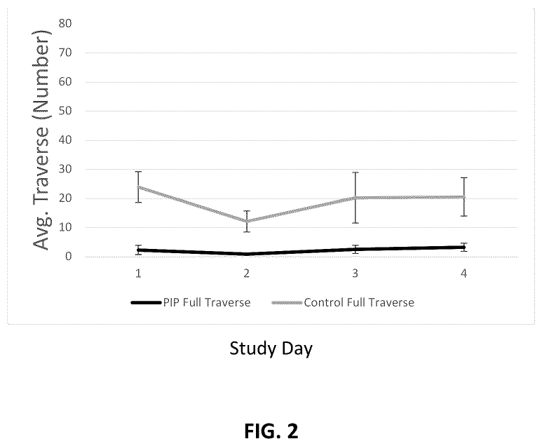

We applied 15 mls of each formulation to portions of the T-maze. During test days 1-2, repellent treatments were located within the distal end of one PVC pipe (medial of nest box) and within the central interior of one randomly-chosen nest box of each T-maze (one treatment in PVC pipe and nest box of one end of each maze; one treatment in each of 4-5 north and 4-5 south nest boxes). We reversed the placement of repellent treatments within each maze during test days 3-4. Traverse data presented in FIG. 1 and FIG. 2 indicate the frequency of occupancy within repellent-treated portions of the T-maze.

### Results

The results of the T-maze experiments for treatment groups 1-6 are provided in FIGS. 1A-1F, respectively. As shown in FIGS. 1E and 1F, the piperine formulation containing 40% vol/vol castor oil, 30% vol/vol propylene glycol, and 10% vol/vol oleic acid (FIG. 1F) resulted in a much lower number of traverses relative to the control formulation containing ethanol (FIG. 1E).

The results of the T-maze experiments for treatment groups 6 and 7 are provided in FIG. 2. The addition of piperine to the castor oil/propylene glycol/oleic acid formulation greatly reduced the number of traverses.

1. A composition comprising 30% to 45% vol/vol castor oil, 25% to 35% vol/vol propylene glycol, 5% to 15% vol/vol oleic acid, 15% to 25% wt/vol rodent repellent, and 0% to 10% vol/vol water.

2. The composition of claim 1, wherein the composition comprises 35% vol/vol castor oil, 30% vol/vol propylene glycol, 10% vol/vol oleic acid, 20% wt/vol rodent repellent, and 5% vol/vol water.

3. The composition of claim 1, wherein the composition comprises 40% vol/vol castor oil, 30% vol/vol propylene glycol, 10% vol/vol oleic acid, and 20% wt/vol rodent repellent.

4. The composition of claim 1, wherein the rodent repellent is selected from the group consisting of capsaicin, cinnamaldehyde, methylnonalketone (MNK), linalool, and piperine.

5. The composition of claim 1, wherein the rodent repellent is piperine.

6. A method of repelling a rodent from a substrate comprising applying to a substrate the composition of claim 1, thereby repelling the rodent from the substrate.

7. A method of enhancing rodent repellency from a substrate comprising applying to a substrate the composition of claim 1, thereby enhancing rodent repellency from the substrate.

8. The method of claim 7, wherein the rodent is a mouse.

9. The method of claim 6, wherein the composition increases rodent repellency relative to a composition that comprises the rodent repellent but does not comprise castor oil, propylene glycol, and oleic acid.

10. The method of claim 6, wherein the castor oil, propylene glycol and oleic acid have a synergistic effect with the rodent repellent in enhancing rodent repellency.
